(19) United States
(12) Patent Application Publication
(10) Pub. No.: US 2009/0306561 A1
(43) Pub. Date: Dec. 10, 2009

(54) WELLNESS THROUGH PERIODIC PULSATING BODY CONTACT

(76) Inventor: Harumi Naganuma, San Francisco, CA (US)

Correspondence Address: LOUIS WU, P.O. BOX 10074, OAKLAND, CA, 94610, US

(21) Appl. No.: 12/478,711

(22) Filed: Jun. 4, 2009

Related U.S. Application Data
(60) Provisional application No. 61/059,740, filed on Jun. 6, 2008.

(51) Int. Cl. A61H 7/00

(52) U.S. Cl. 601/137

(57) ABSTRACT

Wellness device and methods are provided. The device includes a movable head having a smooth convex surface for contact with a body surface of an individual. Also included is a means for automatically moving the head in a recurring manner. When activated, the device allows the smooth convex surface of the head to provide a gentle periodic tapping and/or pulsating sensation on the body surface of the individual at a frequency of about 2.5 Hz or less.

### CROSS REFERENCE TO RELATED APPLICATIONS

This application claims priority to U.S. Provisional Application Ser. No. 61/059,740 entitled “WELLNESS THROUGH PERIODIC PULSATING BODY CONTACT,” filed on Jun. 6, 2008, by inventor Harumi Naganuma, the disclosure of which is incorporated by reference in its entirety.

### BACKGROUND

1. Technical Field

The present invention relates to noninvasive devices and methods for promoting wellness through periodic pulsating body contact. More particularly, the present invention relates to devices and methods that involve periodic pulsating body contact in a gentle localized manner, e.g., to effect lymphatic activation, alleviate pain, relieve stress, and/or facilitate relaxation.

2. Related Art

Wellness is an approach in healthcare that promotes an individual's condition of good physical and mental health. Unlike traditional medical approaches that emphasize the treatment of diseases, the wellness approach typically involves a holistic and balanced preventative regimen that includes proper diet, exercise, and healthful routines and habits. In addition, Eastern wellness approaches may involve treatments that employ minimally invasive or noninvasive procedures often not taught in Western medical schools. For example, therapeutic massage is a commonly known and accepted wellness technique for aiding circulation, relaxing muscles, increasing tissue suppleness, and relieving tension. The efficacy of acupuncture and acupressure practices originating in the East is also well documented in the field of wellness. Such practices have been described as involving the balancing or the replenishing of an individual's “Ch'.”

Professionals in the chiropractic field promote wellness and rehabilitation by focusing on the spine and musculoskeletal system with the intention of affecting the nervous system. It is based on the premise that a spinal joint misalignment can interfere with the nervous system and result in many different conditions of diminished health. In some instances, vertebral adjustment techniques have been used to reduce spinal joint dysfunction and to promote health of the nervous system. In addition or in the alternative, chiropractic therapies have concentrated on the musculoskeletal aspects of components of spinal injury and rehabilitation of the spine.

Chiropractors often engage in spinal manipulation to reduce subluxation. It has been shown to help some symptoms of subluxations such as neck pain and tension type headaches. In particular, chiropractic therapies have been used to alleviate back pain. For example, many people experience back pain. For some, this back pain is a temporary condition and is due in part to a lack of mobility of the back vertebrae and the associated muscles of the back. Those who suffer this type of back pain often describe the condition as stiffness in their back. Many find relief from this condition by way of wellness regimes such as chiropractic therapies and massage therapies. After therapy, patients often feel an instant decrease in back stiffness (e.g., an instant improvement in back mobility), and a corresponding decrease in back pain. Many find this condition to be recurring because of work related activities and the like. Therapy is often repeated as needed by the patient.

The lymphatic system is another critical aspect to a human individual's wellness. The lymphatic system is a subsidiary of the circulatory system that offers a route for the return of tissue fluid to the bloodstream. The system includes lymph capillaries that begin in tissue to collect tissue fluid, i.e., lymph. The capillaries eventually lead into lymphatic vessels which empty lymph into a large vein above the heart. Along the pathway of the lymphatic vessels are specialized structures called lymph nodes. The lymph nodes serve a number of important purposes—as a filter to prevent the spread of infection and as a source of lymphocytes. In contrast to the cardiovascular system which forms a complete circuit, the lymphatic system is a one-way system.

It is well known that the lymph node systems provide a key component for the proper immunological function of mammals. In humans, lymph nodes can be found in high concentration in the face and neck, arm pits, thoracic cavity, intestines and groin, elbows, and knees. Importantly for cancer patients, lymphatic tissue functions in surveillance and defense against foreign cells, microbes, and cancer cells and other pathogens.

A compromised lymphatic system is associated with disease and pain as many lymph nodes and other components of the lymphatic system are located at or near nerve endings. Lymphedema, for example, is a disorder of the lymphatic system wherein excess lymph is accumulated. Such undesirable accumulation causes swelling in different parts throughout the entire body including, but not limited to, the arms and/or legs.

Generally, lymphedema can develop when lymph vessels are missing, impaired or damaged, or when lymph nodes are removed, e.g., as a result of cancer treatments. In essence, lymphedema results when the amount of lymph exceeds local lymphatic transport capacity and an abnormal amount of protein-rich fluid collects in the tissues of the affected area. If left untreated, this stagnant protein-rich fluid causes tissue channels to increase in size and number while reducing the channels' ion exchange capacity, reduces oxygen availability in the transport system, interferes with wound healing and provides a medium in which bacteria can incubate and proliferate, resulting in lymphangitis. The reduction of oxygen also causes lymph nodes to restrict the flow associated with lymphatic drainage. Moreover, such swelling may cause or aggravate hernias.

In cancer patients, new tumors may emerge in the edematous limbs and other portions of the lymphatic system. This is because when lymph flow is reduced, lymphocyte production and ion exchange in these radiation-induced immunologically may be compromised. As a result, tumor cells may take root and grow in edematous body parts.

Lymphedema is treated through a variety of regimens with varying degrees of success. Such regimens often involve compression therapy or mechanical action. For example, U.S. Pat. No. 5,672,148 to Maunier describes a hydraulic device for lymphatic drainage and massage of the human body. This patent describes a device that can transmit a large variety of pressure ranges over any portion of the body with pressure profiles adapted to effect desired lymphatic drainage. In addition, U.S. Pat. No. 5,817,138 to Suzuki describes a method for treating a patient having lymphedema to improve lymphatic flow. The method involves providing multiple pairs of electrodes and pulsing electrical currents through the patient's body using a wave form envelope with a mandatory pause between pulses.

Chiropractic therapies, massage therapies, and other wellness therapies are not always conveniently available when needed, and their costs can be prohibitive for some. Accordingly, many therapeutic wellness devices are commercially available. In some instance, such devices are constructed for use by non-professional persons.

In general, wellness devices are constructed automate or approximate manual action required by the type of wellness therapy that the devices are constructed to carry out. Known wellness therapies, however, generally suffer from a number of shortcomings. For example, chiropractic therapies often require the abrupt application of a high level of pressure. Similarly, massage may involve concentrated application of force, as evidenced by deep muscle therapy and deep tissue techniques. Such massage techniques are required by a practitioner to access deeper layers of soft tissue. Thus, known chiropractic and massage therapies may produce unnecessary damage and inflammation when pressure is applied too deeply or too quickly.

In particular, wellness devices, e.g., massage apparatuses, often include a vibrating member. While the frequency at which the member vibrates may vary, rapid movement is the norm. Even low-frequency settings for many commercially available massage machines may produce a vibration frequency of 10 Hz or more. Such rapid movement are generally jarring in nature, may exacerbate damage caused by excessive pressure and/or may enhance sensations of extreme discomfort.

Recently, it has been discovered that pulsations associated with lymphatic activation is correlated with pain alleviation. For example, U.S. Pat. No. 6,676,686 to Naganuma describes a method for treating disease and alleviating pain associated with the lymphatic system in a living mammalian body. The activation involves placing a stimulation source in physical contact with the closest exterior body surface. In addition, an opposing body surface with respect to the closest exterior body surface is contacted simultaneously with the stimulation source. The stimulation source transfers energy to the affected portion until the localized pulsations substantially subside and/or lymph obstruction is substantially eliminated. This non-invasive method is particularly suited for pain relief and healing.

Nevertheless, further opportunities exist to promote wellness by using devices and methods that improve overall health through the application of periodic localized treatments, e.g., of conditions resulting from lymphatic disorders.

### SUMMARY OF THE INVENTION

In a first embodiment, a wellness device is provided. The device includes a movable head having a smooth convex surface for contact with a body surface of an individual. Also included is a means for automatically moving the head in a recurring manner so as to allow the smooth convex surface of the head to provide a gentle periodic tapping and/or pulsating sensation on the body surface of the individual at a frequency of about 2.5 Hz or less.

Optionally, the device includes a housing having an exterior surface for interfacing with the individual's body surface. In such as case, the housing may be constructed for hand-held comfort, and the head may be movable relative to the exterior body-interfacing surface of the housing. When the housing is provided, the exterior surface of the housing for interfacing with the body surface may be concave. The movable head and/or the head moving means may extend through the exterior surface of the housing.

Further optionally, the device may have an affixable support coupled to the movable head. In such a case, the support may include a clamping mechanism and/or a pivotable arm. The support may be used to position the head and the head-moving means in a manner effective to provide the gentle periodic tapping and/or pulsating sensation on the body surface.

The movable head's construction may vary. For example, the convex surface of movable head may include an elastic material such as a silicone having a hardness of about 30 Shore A to about 50 Shore A. In addition, the convex surface of the movable head may be at least partially hemispherical. Such a head may have a characteristic radius of curvature of about 3.0 mm to about 20 mm.

The head-moving means may vary in construction as well. For example, the head-moving means may be constructed to move the head within a range of motion that corresponds to a distance of 1 mm to about 2 cm. In addition, the head-moving means may be situated such that imposes a force not exceeding about 100 newtons on the body surface of the individual.

A means may be provided for adjusting the frequency at which the head-moving means moves the head. For example, the frequency adjusting means may provide a plurality of discrete frequency settings, e.g., wherein at least one frequency setting such as a 2 Hz setting is an integer multiple of another frequency setting such as a 1 Hz setting. In the alternative, a range of frequency settings may be provided.

Additional features may be provided. For example, the housing may have additional exterior surfaces to facilitate manual placement of the body-interfacing surface of the housing against the body surface. In such a case, at least one of the additional exterior surfaces is concave and borders the body-interfacing surface of the housing. In addition, hand-held device may have a total weight that does not exceed about 500 g and may be powered by a corded electrical power supply and/or a battery. Optionally, aural pulses or other sounds may rhythmically accompany the movement of the head. Such sounds and may be amplified or muffled as desired so as to provide a soothing sensation to the individual. Further optionally, certain features may serve a plurality of purposes. For example, a collar may be provided to muffle sound emerging from the housing and to help stabilize the device against the body surface.

In another embodiment, the invention provides a wellness method that uses the device described above. For example, the device may be positioned the device such that the exterior surface interfaces with a body surface of an individual. When activated, the head-moving means of the device may move the smooth convex surface of the head to impart a gentle periodic tapping and/or pulsating sensation on the body surface at a contact region.

The method may be carried out on different individuals for different purposes. For mammals such as humans, the contact region may encompass a point on the body surface to closest to a lymph node or a point on the body surface that exhibits a symptom due to blockage of the portion of the lymphatic system. In such cases, localized pulsations may be induced that produce lymphatic activation and drainage. Wellness may thus be promoted in individuals with lymphedema and other forms of edema.

Optionally, concurrent to device activation, a body surface region that opposes contact region may be contacted by hand or otherwise so as to sense and/or enhance the induction of the localized pulsations. In some instances, induction of localized pulsations may be enhanced by a periodic rotating manner. When the localized pulsations cease, the head moving means may be deactivated and/or the device may be decoupled from the body surface.

The method may be used to enhance wellness in diseased individuals. For example, the wellness method may be used to treat individuals with cancer and individuals having undergone treatment for cancer such as radiation therapy, chemotherapy or surgery. In addition, persons with autoimmune disease such as rheumatoid arthritis may also be treated with the inventive methods. Obese individuals may also benefit from the inventive method.

Additional embodiments of the invention will be apparent from the disclosure contained herein.

### BRIEF DESCRIPTION OF THE DRAWINGS

FIG. 1 depicts an exemplary portable hand-held device of the invention in cross-sectional view with a movable head in an extended position relative to an exterior housing surface for interfacing with a body surface of an individual.

FIG. 2 depicts the same device in cross-sectional view with the head in a retracted position.

FIG. 3 shows the top of the same device.

FIG. 4 shows bottom of the same device.

FIG. 5 depicts an exemplary device of the invention having a support affixed to a bed on which the individual treated by the device may lie.

FIG. 6 depicts another exemplary portable hand-held device of the invention in cross-sectional view with an extended handle.

FIGS. 7A and 7B, collectively referred to as FIG. 7, depict a collar that may serve to muffle sounds emerging from the device of FIG. 1 and to stabilize the device against the body surface of the individual during the use of the device.

### DETAILED DESCRIPTION OF THE INVENTION

### Definitions and Overview

Before describing the invention in detail, it must be noted that, as used in this specification and the appended claims, the singular forms “a,” “an,” and “the” include plural referents unless the context clearly dictates otherwise. Thus, for example, reference to “a head” includes one or more heads, reference to “a surface” includes a single surface as well as a plurality of surfaces and the like.

In addition, terminology indicative or suggestive of a particular spatial relationship between elements of the invention is to be construed in a relative sense rather an absolute sense unless the context of usage clearly dictates to the contrary. For example, the “top” device surface as used to describe the spatial orientation of the surface does not necessarily indicate that the surface represents the highest point of the device. The surface may be located above, at the same level, or below the center of the device depending on the device's orientation.

In describing and claiming the present invention, the following terminology will be used in accordance with the definitions set out below.

The term “activate” as used herein refers to the inducing of a portion of the lymphatic system to engage in activity that characterizes healthy functioning of that portion. For example, activating a lymph node involves inducing the lymph node to produce lymphocytes and effect filtration of lymph, and activating a portion of the lymphatic system having valves involves opening valves along the lymphatic vessel or system to produce proper lymph flow. Activation is typically accompanied by localized pulsations.

The term “body” as in an “individual's body” refers to the physical structure of the individual. The term “body” as used to describe a mammal such as a human is not limited to the human's torso and includes the mammal's head, limbs, appendages, and etc.

The term “localized pulsations” is used herein to refer to a substantially rhythmic throbbing or vibration in a mammalian body, wherein the substantially rhythmic throbbing is detectable near the source of the pulsation. Depending on the intensity at the source of the pulsation, localized pulsations are typically detectable only at a portion of the body surface near the source of the pulsation, i.e., a malfunctioning portion of the lymphatic system, typically a lymph node. Without invasive means, the localized pulsations are typically most easily detected at the exterior body surface closest to the source of the pulsation and sometimes, to a lesser degree, at the opposing body surface with respect to the closest exterior body surface.

The term “obese” as used herein refers to a state of a mammalian body in which the ratio of fat to lean body mass is at least about 20 percent higher than the accepted norm for healthy functioning of the body.

The term “opposing body surface with respect to the closest exterior body surface” as used herein refers to the location on the body surface that intersects a line extending through both the interior of the body affected by a lymphatic disorder and the closest exterior body surface thereto.

The term “physical contact” as used herein refers to the contact between two bodies in such a way that the surfaces of the bodies are substantially immobile with respect to each other. In other words, the surfaces of the bodies may exhibit only slight movement with respect to each other. In addition, pressure between the contacting surfaces is maintained at a substantially constant level. Ordinary massage techniques, acupressure, and other forms of motion is neither desirable nor required for physical contact.

The term “stimulation source” as used herein refers to a body that is capable of conducting energy to another body surface. Energy from the stimulation source may be mechanical, electrical, magnetic, thermal and/or of a yet unidentified character such that when such energy is applied to an affected portion of the lymphatic system, promotes lymphatic activation and healing that is characterized by localized pulsations.

The term “Shore A” refers to a measure of a material's hardness using a durometer, e.g., similar to that described in U.S. Pat. No. 1,770,045 to Shore et al.

In general, the invention provides an improvement and/or modification of the art described in U.S. Pat. No. 6,676,686 to Naganuma. As described therein, many disorders are associated with a lymph node or a portion of the lymphatic system. Such lymphatic structures may be activated or drained through pulsation-inducing energy transfer. These pulsations form a basis of the invention which allows noninvasive detection and activation of the lymphatic system in treating disease and alleviating pain.

It has now been discovered that energy, e.g., mechanical energy, in the form of a gentle periodic tapping and/or pulsating sensation on a contact region of the body surface of an individual can be used to effect lymphatic healing with or without contacting another body surface region that opposes the contact region. The mechanical energy may be applied at a regular interval that corresponds to frequency of about 2.5 Hz or less. Such treatments and promote a sense of wellbeing and comfort. While lymphatic wellness typically involves the application of the tapping and/or pulsating sensation to a contact region near a lymph node, a mechanical energy transfer in the form of tapping and/or pulsating sensation to a contact region away from a lymph node, surprisingly, may also promote a sense of wellbeing and comfort.

The invention thus relates to wellness methods and devices that apply gentle energy at a low frequency. Typically, devices of the invention include a movable head having a smooth convex surface for contact with a body surface of an individual. Also included is a means for automatically moving the head in a recurring manner so as to allow the smooth convex surface of the head to provide a gentle periodic tapping and/or pulsating sensation on the body surface of the individual at a frequency of about 2.5 Hz or less.

An Exemplary Handheld Device

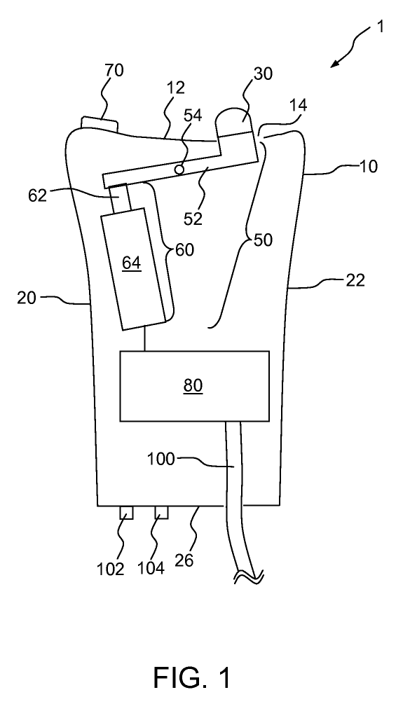

The inventive methods and devices may be embodied in different forms. For example, the invention may be carried out using a lightweight handheld device, e.g., not exceeding about 500 g, for promoting wellness as depicted in FIGS. 1-4. As with all figures referenced herein, in which like parts are referenced by like numerals, FIGS. 1-4 is not to scale, and certain dimensions may be exaggerated for clarity of presentation. As shown, the device 1 includes a housing 10, a movable head 30, and an automatic means 50 for moving the head.

The housing may be shaped for comfortable fit in ordinary human hand. While the housing may be specifically shaped right-handed or left-handed fit, the housing shown in FIGS. 1-5 is designed for comfort in either hand. As shown, the housing 10 has a generally flat and elongate exterior shape defined by a top surface 12, a front surface 20, a back surface 22, side surfaces 24, and a bottom surface 26. The surfaces generally join each other via rounded edges, corners and vertices.

The top and bottom surfaces oppose each other are generally elliptical in shape. The top surface 12 is larger than the bottom surface 26, and the distance between them generally define the length of the housing 10. The distance between the front and back surfaces generally define the width of the device, and the distance between the side surface 24 generally define the thickness of the device. As shown, the bottom surface is substantially planar.

In some instances, the side surfaces 24 may be substantially flat. However, as shown, each of the front, side, and/or back surfaces may have a generally convex curvature perpendicular to the length of the device 1. The side surfaces, as shown, have a greater radius curvature than either the front surface 20 or back surface 22. However, the front and back surfaces may exhibit a generally concave profile along the length of the device 1 such that the front and back surfaces have a saddle-like contour.

The device 1 may be constructed in any of a number of different dimensions as long as it is fits comfortably in an ordinary human hand. The device shown in FIGS. 1-4 may be sized to have a length of about 5 to about 15 cm, a width of about 3 to about 10 cm, and thickness of about 2 to about 5 cm. The device 1 shown in FIGS. 1-4 has a length of about 11.4 cm, a width of about 6.5 cm, and a thickness about 3.5 cm.

The housing 10 may be made from a unitary piece. However, it may be more convenient from a manufacturing perspective to form the housing by joining parts to form the whole. In some instances, the housing may be formed from two symmetrical side-by-side halves joined at a seam that extends along the top, front, back, bottom surfaces. The front and back surfaces may exhibit mirror symmetry as well.

The housing 10 may be made from any of a number of materials. While the housing 10 may be metallic, ceramic, glass, and/or polymeric, polymeric materials are generally preferred due to their low density, formability, and mechanical properties that provide them with a comfortable hand feel. Suitable polymeric materials include, for example, polyalkylenes such as polyethylene, polypropylene and polybutylene, chlorinated or fluorinated polyalkenes such as polyvinyl chlorides, polyvinyl fluorides, polyvinylidene fluorides, and polytetrafluoroethylene, polystyrenes, polycarbonates, polyalkadienes, polyesters, polyacrylonitriles, polyamides, copolymers thereof, and mixtures of any of the foregoing.

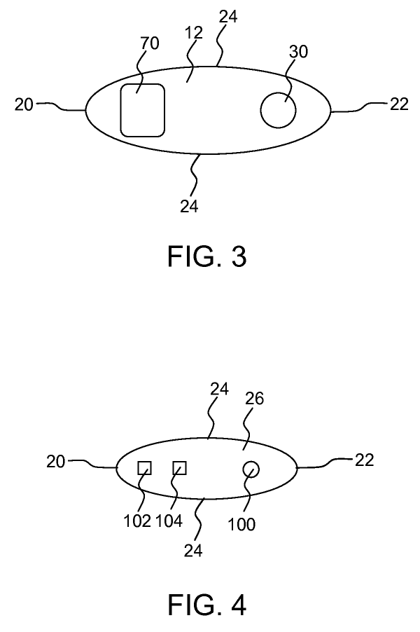

The top surface 12 of the device 1 has a generally concave profile and an opening 14 through which the movable head 30 may extend. As shown in FIG. 3, the top surface 12 of the device has opening 14 is located closer to the back than the front side of the device. In contrast, a soft pad 70 is attached to the top surface 12 closer to the front of the device 1. As the pad 70 is intended to interface with a body surface, the material for the pad should be selected for comfort. For example, the pad may be made from any soft material that has some “give.” In some instances, the pad may be made from a spongy foam, fabric or composite material. A solid polymeric elastic material may be used as well in some instances. The surface and bulk properties of the pad may provide a feeling of luxuriousness. The properties should be more provide static and dynamic tactile sensation more akin to that associated with powder puffs or other applicator for skin cosmetics rather than with that associated with burlap or sandstone.

The moveable head 30 may also have different geometries and dimensions. Typically, the head has a smooth convex surface for comfortable contact with a body surface of an individual. The surface may be at least partially hemispherical and/or be devoid of shape edges and corners. When the surface is curved, the surface may exhibit a characteristic radius of curvature. Typically, the characteristic radius is about 3.0 mm to about 20 mm. Optimally, the characteristic radius is about 4.0 mm to about 10 mm.

The head may be made from a material selected for comfort as well. For example, the convex surface of movable head may be formed from an elastic material. The materials typically have a hardness of about 30 Shore A to about 50 Shore A. Optimally, the hardness is about 35 Shore A to about 45 Shore A.

As shown, the head 30 is attached to automatic means 50 which is constructed to moves the head in a cyclic or recurring manner relative to the housing. The automatic means 50 is contained within the housing 10 and includes a lever 52 that pivots about fulcrum point 54, which is immobilized relative to the housing 10. From the fulcrum point 54, the lever 52 extends toward the back of the device and terminates at a first terminus 54, which is attached to the head 30. The lever 52 extends and a second terminus attached to a solenoid actuator 60.

The solenoid actuator 60 is also immobilized relative to the housing 10. The actuator includes a piston 62 slidably disposed within a casing 64. The relative positions of the piston 62 and the casing 64 depend on whether the actuator 60 is actuated or unactuated. The actuator 60 may be powered by any of a number of different types of power sources 80. In some instances, a corded electrical power supply may be used. In such a case, as shown in FIG. 4, an electrical cord 100 may extend through the bottom of the housing 10. An electrochemical cell or battery (not shown) may be used as well.

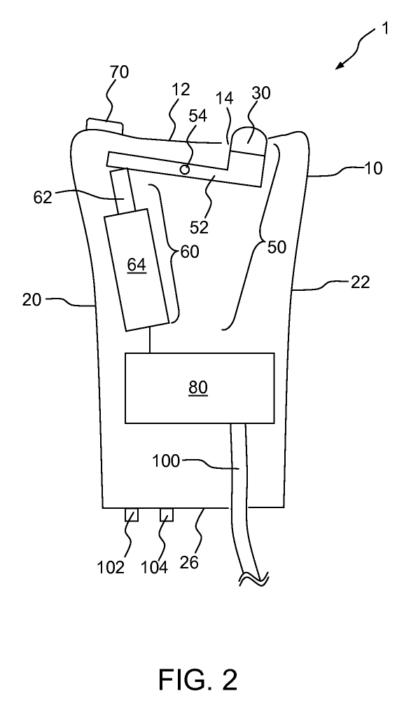

In general, the automatic means 50 for moving the head cycles through two operational states, actuated and unactuated. FIG. 1 shows the automatic means 50 is an unactuated state. As shown, the piston 62 is in a retracted state relative to the casing 64 of the actuator 60, and the head 30 extends through the top surface opening 14 of the housing 10. As a result, substantially the entirety of the head 30 is external to the housing 10. In contrast, FIG. 2 depict shows the same device shown in FIG. 1 except that the automatic means 50 is in an actuated state. As shown, the piston 62 is in an extended state relative to the casing 64 of the actuator 60. The head 30 is located substantially entirely within the housing 10.

As discussed above, the device may be constructed to provide a gentle periodic tapping and/or pulsating sensation on the body surface of the individual at a frequency of about 2.5 Hz or less. However, the particular frequency that the device may be operated may vary. For example, the device may be constructed to operate at a single or a plurality of frequencies. The frequencies may vary or remain constant.

Thus, the device may include any of a number of known means for adjusting the frequency at which the head-moving means for automatically moves the head. The frequency adjusting means may provide a plurality of discrete frequency settings. When a plurality of frequency setting are available, at least one frequency setting may be an integer multiple of another frequency setting. For example, one frequency setting may be about 1 Hz and another frequency setting may be about 2 Hz. The frequency adjusting means may provide a range of frequency settings as well. For example, as shown in FIG. 4, switches 102 and 104 may be accessible located through the bottom surface of the housing. Switch 102 represents an on-off power switch to the device and switch 104 may be used to adjust and/or set the frequency for head movement.

To provide a gentle periodic tapping and/or pulsating sensation on the body surface, the automatic means for moving the head may be constructed to provide different ranges of motion and forces. For example, head-moving means may be constructed to move the head, when unconstrained, within a range of motion that corresponds to a distance of 1 mm to about 2 cm. Optionally, the range of motion may correspond to a distance of about 2 mm to about 10 mm. To ensure that the head does not cause discomfort, the head-moving means may be constructed such that the head imposes a force that does not exceed about 50 to about 100 newtons on a body surface of an individual.

Along with the tactile tapping sensation, the inventive device may be constructed to emit aural pulses or other sounds that further promote a sense of wellbeing and comfort. Typically, the aural pulses or sounds rhythmically accompany the movement of the head so as to work in synergy with the periodic tapping and/or tactile pulsation on the individual's body surface. Such aural pulsations may be similar in character to the sounds made by a metronome. While not wishing to be bound by theory, it is believed that the aural pulsation and the periodic tapping in conjunction may operate in a manner similar to how a car ride or the combination of a rocking motion and a gentle lullaby may provide a sense of comfort to an infant, allowing the infant to fall asleep.

In some instances, the aural pulsation may be generated as a by-product of the operation of the actuator. For example, an aural pulsation may be generated whenever the actuator 60 is actuated. In addition or in the alternative, the aural pulsations may occur whenever the actuator 60 is in an unactuated state. Furthermore, aural pulsations may occur whenever the piston 62 is in motion.

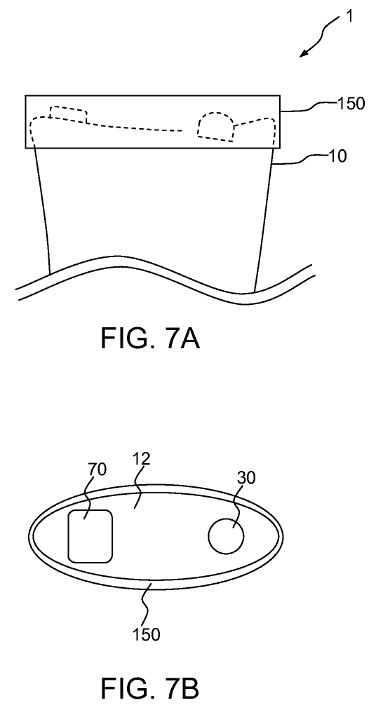

A means for moderating the aural pulsation may be provided to effect aural amplification or muffling. As shown in FIG. 7, a collar 150 may be used in conjunction with the device 1 depicted in FIGS. 1-4. The collar 150 conformally contacts and circumscribes the housing 10 near the top surface 12. The collar 150 may be made from a material selected for mechanical properties suitable for conformal contact with the body surface against which the head 30 of the device may tap. For example, the material may have a similar feel as either the material used to make pad 70 or head 30. Such a collar 150, when used with the device and placed against the body surface, may serve to muffle sounds emerging from the device through the opening 14 of the housing 10.

In any case, any means to emit or influence the volume of aural pulses or other sounds effect should be implemented in a manner that does not interfere with the operation of the device 1. For example the collar 150 should be of a geometry and/or mechanical property such that its presence does not prohibit contact between pad 70 and the body surface of the individual under treatment. Similarly, the collar 150 should not prevent the head 30 from contacting the body surface.

In certain instances, certain features of the invention may serve a plurality of purposes. For example, the collar 150 may serve dual purposes: to muffle sound emergins from the device and to help a user stabilize the device against the body surface of the individual. In such a case, the collar should be constructed a material suitable for both purposes. For example, the material should have both sound blocking properties as well as appropriate mechanical properties to effect device stabilization without causing discomfort to the individual under treatment.

Affixable Devices

The invention is not limited to handheld devices. For example, another embodiment of the invention provides an affixable wellness device. The embodiment includes an affixable support, a head movably coupled to the support, and a means for automatically moving the head. The head has a smooth convex surface for contact with a body surface of an individual. The head moving means automatically moves the head in a recurring manner as described above so as to allow the smooth convex surface of the head to provide a gentle periodic tapping and/or pulsating sensation on the body surface of the individual.

Any of a number of supports may be used. For example, the support may include a clamping mechanism. Clamping mechanisms may include any of various apparatus or set ups used to join grip, support, or compress mechanical or structural parts. Such mechanisms may include any of various tools with opposing, adjustable sides or parts for bracing objects or holding them together. In some instances, spring-loaded mechanisms may be used. Often, the clamp may include movable pieces made of a soft material to cover the harder structural elements to enable the clamp to grasp without bruising.

Similarly, the support may include an arm or other type of structural element for positioning the head and the head-moving means in position to provide the gentle periodic tapping and/or pulsating sensation on the body surface. For example, the arm may provide for one, two, three, four, five, six, seven or more degrees of freedom so as to allow for proper positioning and orientation of the head and the head-moving means for optimal operation. The degrees of freedom may be rotational and or translational. The arm may include different types of joints, e.g., ball and socket, ellipsoid, saddle, hinge, pivot, etc. and/or extension mechanisms, e.g., telescoping, sliding, etc. Similarly, rigid, elastic, and/or plastic materials may be used to form the support.

Optionally, a housing may be provided. The housing may form a portion of the support or be detachably engaged with the support. Thus, for example, when the housing is shaped for comfortable fit in ordinary human hand, the support may include an engaging mechanism having a corresponding shape to allow the housing to be snapped therein.

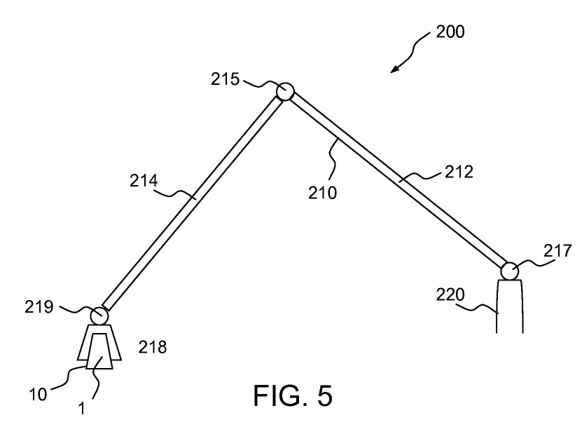

As shown in FIG. 5, the handheld device 1 of FIGS. 1-4 is provided with a support 200 that includes an arm 210 and a clamping mechanism 220 in the form of a spring-loaded clip. The arm is generally divided into first and second sections, indicated at 212 and 214, respectively by joint 215. The clip 220 is joined with the first arm section 212 at a terminus opposing joint 215 via a ball and socket joint 217. As a result, the clip 220 may be rotated and/or positioned at a wide range of angles relative to the arm 210. Similarly, attached to the second arm section 214 at a terminus opposing joint 215 is a bracket 218 shaped to engage the housing 10 of the device 1. The bracket 218 is also joined to the arm 210 via a ball and socket joint 219 in a rotationally pivotable manner. Unlike joints 217 and 219, joint 215 may be a hinge joint that allows first and second arms sections 214 and 216, respectively, to be positioned at a wide range of angles along a fixed plane.

As shown, the clamping mechanism 220 is engaged with the headboard of a bed 230. In addition, the bracket 219 is engaged to the device housing 10. As the arm 210 has an extended length that exceeds that of the bed 230 is should be apparent that the device 1 may be positioned to apply appropriate mechanical energy may to any exposed surface of an individual lying on the bed. Optimally, once in position, the device may be activated to apply a tapping and/or pulsating sensation to a contact region near a lymph node in a hands-free manner.

### AN EXEMPLARY METHOD

The invention also provides a wellness method that uses the above-described device. As discussed above the device include an exterior surface, a movable head having a smooth convex surface, and a means for automatically moving the head in a recurring manner relative to the surface at a frequency of about 2.5 Hz or less. In operation, the device may be positioned such that the exterior surface interfaces with a body surface of an individual. The head-moving means of the device may be activated such that the smooth convex surface of the head provides a gentle periodic tapping and/or pulsating sensation on the body surface at a contact region. To provide a feeling of wellness, the tapping and/or pulsating sensation ideally should not cause substantial continuous blanching of the tissue near the area of contact. By “blanching” it is meant that body fluid such as blood or lymph is occluded from a region of tissue such that the region is drained of color and appears white. Such blanching is typically indicative of excessive pressure that would be discomforting to the individual.

Typically, the invention may be used to provide a sense of wellbeing and comfort to mammals such as humans. When the method is used to promote lymphatic wellness, the contact region may encompass a point on the body surface to closest to a lymph node. In addition, the invention may be used to supplement or as an alternative the method described in U.S. Pat. No. 6,676,686 to Naganuma. For example, the invention may be practiced such that the contact region represents the closest exterior body surface to lymphatic tissue affected by the disorder.

In order to determine the closest exterior body surface that may be treated with the inventive device, one may employ any of a number of methods, e.g., monitoring external swelling, detecting temperature change, assessing level of pain, or tagging affected lymphatic tissue with radiopharmaceuticals or magnetic media. In some instances, known medical technologies, e.g., those involving electrical and/or mechanical devices, may be used to carry out such methods. For example thermal couples thermometers may be used to detect temperature changes.

However, none of these methods is an ideal substitute for detecting pulsations that occur only when a malfunctioning portion of the lymphatic responses to energy transfer from a stimulation source as described below. In other words, external swelling is not necessarily an indication of a lymphatic disorder characterized by localized pulsations. To detect such pulsations by touch, one of typically places a hand on the external surface of the affected body. The hand, usually the palm side, is slid across the surface to sense the area on which the pulsations are most strongly detected. Fingertips are particularly sensitive to such pulsations. Touch may involve direct skin-to-skin contact or contact through clothing or other materials.

Sometimes, when the disorder is severe, the pulsation can also be detected as sound, in which case physical contact is helpful to locate the precise location where the pulsations are strongest. Alternatively, a sound detector may be employed. Such sounds may be recorded by employing a microphone at or near the area of treatment, before, during or after treatment. The sound recordings may be made through the use of a contact microphone substantially immobilized with respect to exterior surfaces of a human subject near a dysfunctional lymph node. Such contact microphones are well known in the art and are commercially available from a number of manufacturers and vendors.

In addition, the pulsations may be detected as a palpitation. When the pulsations are present, such pulsations are recognizable by trained human touch. One who is able to detect such pulsations may train another by example, e.g., identifying individuals who suffer from the lymphatic disorder, detecting the localized pulsations, allowing the trainee to touch the affected area on the individual to feel the localized pulsations, and comparing the tactile sensation to an unaffected area or the corresponding area on an unaffected individual. Success from such training may vary with the skill of the teacher and the natural abilities of the student. In some cases, an individual may be able to detect such pulsations without training from another. Additional details regarding the detection of pulsations and/or palpitations may be found in U.S. Pat. No. 6,676,686 to Naganuma.

Once the affected lymphatic region is located, through conventional methods or by detecting pulsations, treatment of the disorder may then take place. Depending on the disorder, treatment methods may vary. For example, when the invention is used to treat an individual with a lymphatic disorder, the contract region may encompass a point that exhibits a symptom due to blockage of the portion of the lymphatic system.

As discussed above, the invention may involve the step of activating the head-moving means is activated such that the smooth convex surface of the head provides a gentle periodic tapping and/or pulsating sensation on the body surface at a contact region. The step may be carried out to induce localized pulsations that characterize lymphatic activation and drainage. Concurrently, a wellness practitioner may contact body surface region that opposes contact region so as to sense the localized pulsations or in a manner effective to enhance the induction of localized pulsations. This may be carried out in a periodic rotating manner and/or by hand.

### VARIATIONS OF THE INVENTION

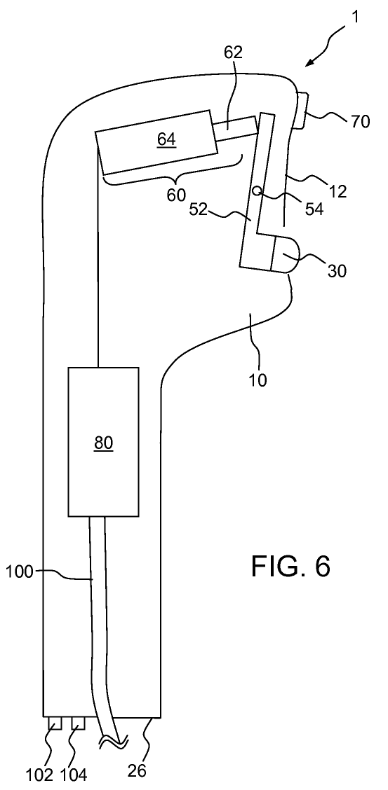

Numerous variations of the invention are possible. For example, while the inventive device is not limited to the construction shown in FIG. 1. As shown in FIG. 6, the housing 10, may be altered to exhibit a generally elongate and curved geometry instead of that shown in FIG. 1. As a result, that the interfacing surface 12 may extends at an angle relative to the length of the housing. In addition, the portion of the housing closer to the bottom surface 26 may serve as a handle to increase the reach of a user.

In any case, the invention may be used to promote wellness in any mammalian body. For example, the invention may promote wellness in individuals that show symptoms of various disorders such as edema, e.g., lymphedema, cancer, an autoimmune diseases, e.g., rheumatoid arthritis. Similarly, the invention may promote wellness in those who have undergone treatment for such disorders. For example, the invention may be used to treat those having undergone remedial regimen for cancer, e.g., radiation therapy, chemotherapy or surgery. In addition, the invention may be used to promote wellness for those experiencing stress or obesity.

It is to be understood that while the invention has been described in conjunction with the preferred specific embodiments thereof, that the foregoing description is intended to illustrate and not limit the scope of the invention. Other aspects, advantages and modifications within the scope of the invention will be apparent to those skilled in the art to which the invention pertains.

All patents, patent applications, and publications mentioned herein are hereby incorporated by reference in their entireties.

I claim:

1. A wellness device, comprising:
a housing having an exterior surface for interfacing with a body surface of an individual;
a movable head having a smooth convex surface for contact with the body surface; and
a means for automatically moving the head in a recurring manner relative to the exterior body-interfacing surface of the housing so as to allow the smooth convex surface of the head to provide a gentle periodic tapping and/or pulsating sensation on the body surface of the individual at a frequency of about 2.5 Hz or less.

2. The device of claim 1, wherein the exterior surface of the housing for interfacing with the body surface is concave.

3. The device of claim 1, wherein the movable head and/or the head moving means extends through the exterior surface of the housing.

4. The device of claim 1, wherein the convex surface of movable head comprises an elastic material.

5. The device of claim 4, wherein the elastic material has a hardness of about 30 Shore A to about 50 Shore A.

6. The device of claim 5, wherein the hardness is about 35 Shore A to about 45 Shore A.

7. The device of claim 1, wherein the convex surface of the movable head is at least partially hemispherical.

8. The device of claim 1, wherein the convex surface of the movable head has a characteristic radius of curvature of about 3.0 mm to about 20 mm.

9. The device of claim 8, wherein the characteristic radius of curvature is about 4.0 mm to about 10 mm.

10. The device of claim 1, wherein head-moving means is effective to move the head, when unconstrained, within a range of motion that corresponds to a distance of 1 mm to about 2 cm.

11. The device of claim 10, wherein the range of motion corresponds to a distance of about 2 mm to about 10 mm.

12. The device of claim 1, wherein the head-moving means is effective to move the head such that the head imposes a force that does not exceed about 100 newtons on the body surface of the individual.

13. The device of claim 12, wherein the force does not exceed about 50 newtons on the body surface of the individual.

14. The device of claim 1, further comprising a means for adjusting the frequency at which the head-moving means for automatically moves the head.

15. The device of claim 14, wherein the frequency adjusting means provides a plurality of discrete frequency settings.

16. The device of claim 15, wherein at least one frequency setting is an integer multiple of another frequency setting.

17. The device of claim 16, wherein one frequency setting is about 1 Hz and another frequency setting is about 2 Hz.

18. The device of claim 14, wherein the frequency adjusting means provides a range of frequency settings.

19. The device of claim 1, wherein the housing has additional exterior surfaces to facilitate manual placement of the body-interfacing surface of the housing against the body surface.

20. The device of claim 19, wherein at least one of the additional exterior surfaces is concave and borders the body-interfacing surface of the housing.

21. The device of claim 1, further comprising a corded electrical power supply to power the head-moving means.

22. The device of claim 1, further comprising a battery to power the head-moving means.

23. The device of claim 1, having a total weight that does not exceed 500 g.

24. The device of claim 1, further comprising a sound muffling and/or device stabilizing collar.

25. A wellness device, comprising:
an affixable support;
a head movably coupled to the support and having a smooth convex surface for contact with a body surface of an individual; and
a means for automatically moving the head in a recurring manner so as to allow the smooth convex surface of the head to provide a gentle periodic tapping and/or pulsating sensation on the body surface of the individual at a frequency of about 2.5 Hz or less.

26. The device of claim 25, wherein the support includes a clamping mechanism.

27. The device of claim 25, wherein the support includes a pivotable arm for positioning the head and the head-moving means in position to provide the gentle periodic tapping and/or pulsating sensation on the body surface.

28. A wellness method, comprising:
(a) providing a wellness device comprising,
an exterior surface,
a movable head having a smooth convex surface, and
a means for automatically moving the head in a recurring manner relative to the exterior surface at a frequency of about 2.5 Hz or less;
(b) positioning the device such that the surface interfaces with a body surface of an individual; and
(c) activating the head-moving means of the device such that the smooth convex surface of the head provides a gentle periodic tapping and/or pulsating sensation on the body surface at a contact region.

29. The method of claim 28, wherein the individual is mammalian.

30. The method of claim 29, the contact region encompasses a point on the body surface to closest to a lymph node.

31. The method of claim 29, wherein the contact region encompasses a point on the body surface that exhibits a symptom due to blockage of the portion of the lymphatic system.

32. The method of claim 29, wherein step (c) is carried out to induce localized pulsations that characterize lymphatic activation and drainage.

33. The method of claim 32, further comprising, concurrent to step (c), (c1) contacting a body surface region that opposes contact region so as to sense the localized pulsations.

34. The method of claim 33, wherein step (c1) is carried out by hand.

35. The method of claim 32, further comprising, concurrent to step (c), (c1) contacting a body surface region that opposes contact region in a manner effective to enhance the induction of localized pulsations.

36. The method of claim 35, wherein step (c1) is carried out in a periodic rotating manner.

37. The method of claim 32, further comprising, (d) deactivating the head moving means and/or decoupling the device from the body surface when the localized pulsations cease.

38. The method of claim 29, wherein the living mammalian body is human.

39. The method of claim 38, wherein the living mammalian body exhibits edema.

40. The method of claim 39, wherein the edema is lymphedema.

41. The method of claim 38, wherein the living mammalian body exhibits cancer.

42. The method of claim 38, wherein the living mammalian body has undergone treatment for cancer.

43. The method of claim 42, wherein the treatment for cancer comprises radiation therapy, chemotherapy or surgery.

44. The method of claim 38, wherein the living mammalian body exhibits an autoimmune disease.

45. The method of claim 44, where the autoimmune disease is rheumatoid arthritis.

46. The method of claim 38, wherein the living mammalian body is obese.
